(19) United States
(12) Patent Application Publication
(10) Pub. No.: US 2013/0145068 A1
(43) Pub. Date: Jun. 6, 2013

(54) UNIVERSAL SERIAL BUS DEVICE FOR HIGH-EFFICIENT TRANSMISSION

(71) Applicants: Wei-Cheng HUNG, Hsinchu (TW); Wei-Lu Su, Hsinchu (TW); Che-Wei Chang, Hsinchu (TW)

(72) Inventors: Wei-Cheng HUNG, Hsinchu (TW); Wei-Lu Su, Hsinchu (TW); Che-Wei Chang, Hsinchu (TW)

(21) Appl. No.: 13/365,987

(22) Filed: Feb. 3, 2012

(30) Foreign Application Priority Data
Dec. 5, 2011 (TW) 100144570

(51) Int. Cl. G06F 13/14

(52) U.S. Cl. 710/305

(57) ABSTRACT

The present invention discloses a Universal Serial Bus (“USB”) device that includes an Ethernet port configured to receive a first Ethernet packet, and an input control circuit including a data register memory, a header register memory and an input data control circuit. The input data control circuit, upon receiving a first Ethernet packet, stores first packet data of the first Ethernet packet in the data register memory, transmits the first packet data to a USB host, and, in response to the transmission of the first packet data, stores first header data of the first Ethernet packet in the header register memory.

### BACKGROUND OF THE INVENTION

1. Technical Field

The present invention relates to a Universal Serial Bus device, and more particularly, to a Universal Serial Bus device for high-efficient transmission.

2. Background

A Universal Serial Bus (USB) device, in transmitting data via an Ethernet port toward a USB host, stores Ethernet packets in a data register memory of a bulk transmission input control circuit. After a first Ethernet packet is stored in the data register memory, an input data control circuit of the bulk transmission input control circuit determines whether to receive the first Ethernet packet. After the input data control circuit determines to receive the first Ethernet packet, the header data of the first Ethernet packet are transmitted to the USB host. The header data indicate the length of the first Ethernet packet and the packet type. Subsequently, the input data control circuit retrieves the temporarily stored Ethernet packet from the data register memory and transmits the same to the USB host. Meanwhile, the input data control circuit begins to receive a second Ethernet packet and store the second Ethernet packet in the data register memory as the first Ethernet packet is retrieved. The first Ethernet packet is not overwritten by the second Ethernet packet. When the first Ethernet packet has been completely transmitted to the host, the first Ethernet packet is erased from the data register memory. After the second Ethernet packet has been temporarily stored in the data register memory, the input data control circuit of the bulk transmission input control circuit determines whether to receive the second Ethernet packet. After the input data control circuit determines to receive the second Ethernet packet, the header data of the second Ethernet packet are transmitted to the USB host, and then the second Ethernet packet are transmitted from the data register memory to the USB host.

FIG. 1 shows a block diagram of a Universal Serial Bus (USB) system in prior art. Referring to FIG. 1, the USB system includes a USB device 10 and a USB host 18. The USB device 10 includes an Ethernet port 11, a USB port 201, a bulk transmission output control circuit 13, and a conventional bulk transmission input control circuit 12.

The USB device 10 connects to an external device (not shown) by a twisted line 15 and, via the Ethernet port 11 and the conventional bulk transmission input control circuit 12, sends input data in a format 14 to the USB port 201. The USB device 10, via the USB port 201, transmits data 17 in a bulk transmission input frame format through a USB transmission line 16 and a USB port 202 to a USB driver 19 of the USB host 18.

The USB host 18 connects to the USB device 10 through the USB port 202 and the USB transmission line 16, and connects via the USB port 201, the bulk transmission output control circuit 13 and the Ethernet port 11 to the twisted line 15 so as to transmit data to the external device.

FIG. 2 shows the input data format 14 in the USB system of FIG. 1. Referring to FIG. 2, the input data format 14 includes a plurality of input packet headers and a plurality of input packet data.

FIG. 3 shows the bulk transmission input frame format data 17 in the USB system of FIG. 1. Referring to FIG. 3, the bulk transmission input frame format data 17 include a plurality of input packet header data, a plurality of input packet data and a plurality of complete bulk transmission data.

The bulk transmission input frame format data 17 include a plurality of USB packets. Each of the USB packets includes at least one input packet header data, at least one input packet data and a piece of complete bulk transmission data.

FIG. 4 shows a block diagram of the bulk transmission input control circuit 12 of FIG. 1. Referring to FIG. 4, the bulk transmission control circuit 12 includes an input data control circuit 121 and a data register memory 122.

The data register memory 122 is used to temporarily store an Ethernet packet. The input data control circuit 121, upon receiving an Ethernet packet, temporarily stores the received Ethernet packet in the data register memory 122 and organizes the header data of the Ethernet packet, the data of the Ethernet packet and the complete bulk transmission data in the input data format 14.

In the above-mentioned mechanism, the system does not transmit data to the USB host 18 until each Ethernet packet is completely transmitted. Accordingly, the capacity of the data register memory may need to be adjusted in accordance with the size of Ethernet packet transmission. If the Ethernet packet received has a jumbo frame format, the capacity of the data register memory needs to be expanded, which will incur an increase in the cost of the data register memory. Therefore, the efficiency of the prior art Ethernet packet data transmission to the USB host 18 may be limited by such mechanism.

For the reasons as described above, it may be desirable to have an improved data transmission mechanism for efficient transmission from a USB device to a USB host.

### SUMMARY

A USB device comprises an Ethernet port to receive a first Ethernet packet, and an input control circuit comprising a data register memory, a header register memory and an input data control circuit. The input data control circuit, upon receiving a first Ethernet packet, temporarily stores a first packet data of the first Ethernet packet in the data register memory, then transmits the first packet data to a USB host. After transmitting the first packet data, the input data control circuit temporarily stores a first header data of the first Ethernet packet in the header register memory.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 shows a block diagram of a Universal Serial Bus (USB) system in prior art;

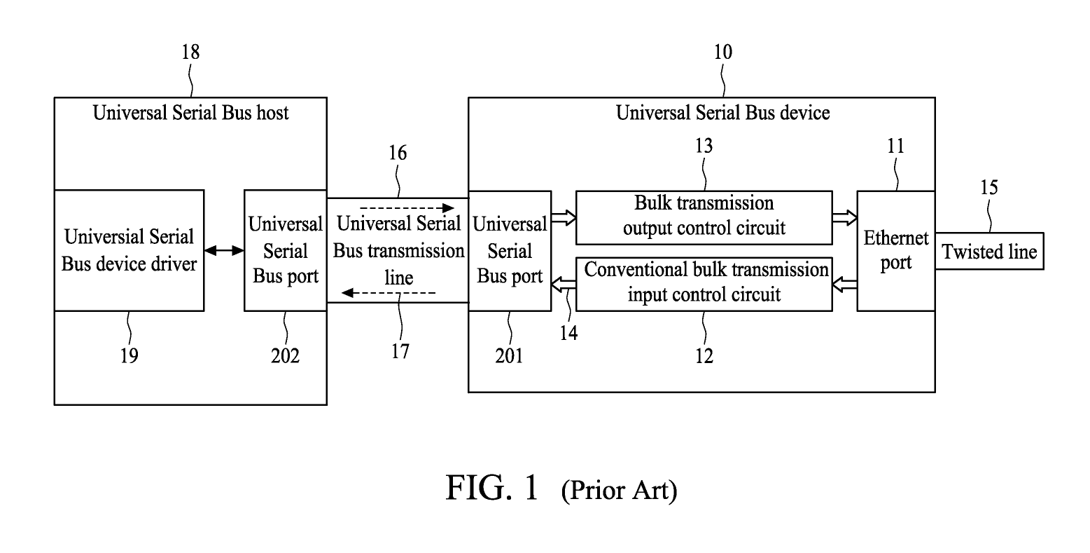

FIG. 2 shows an input data format in the USB system of FIG. 1;

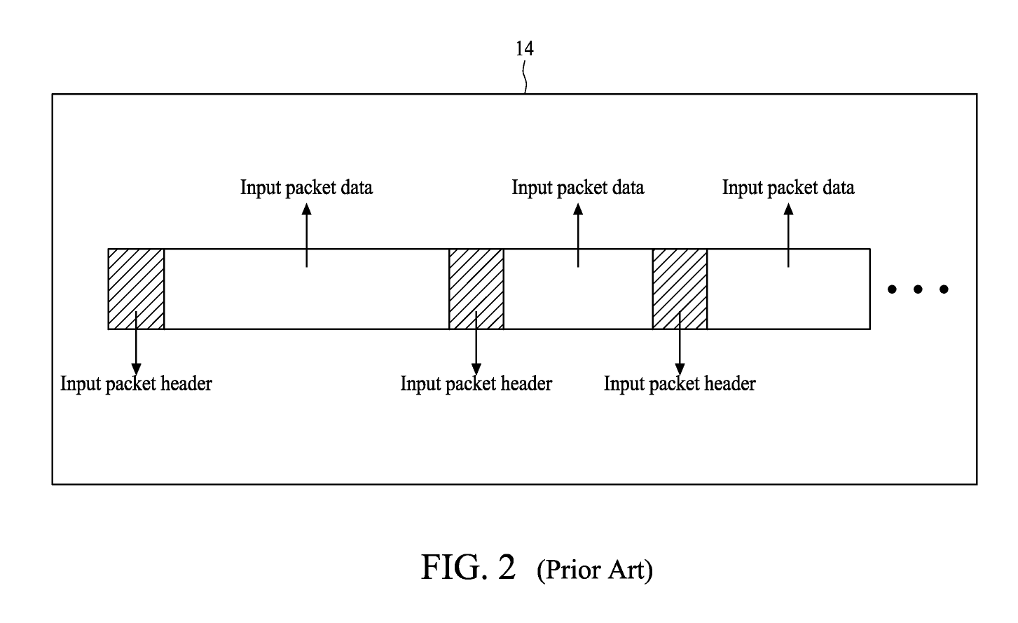

FIG. 3 shows bulk transmission input frame format data in the USB system of FIG. 1;

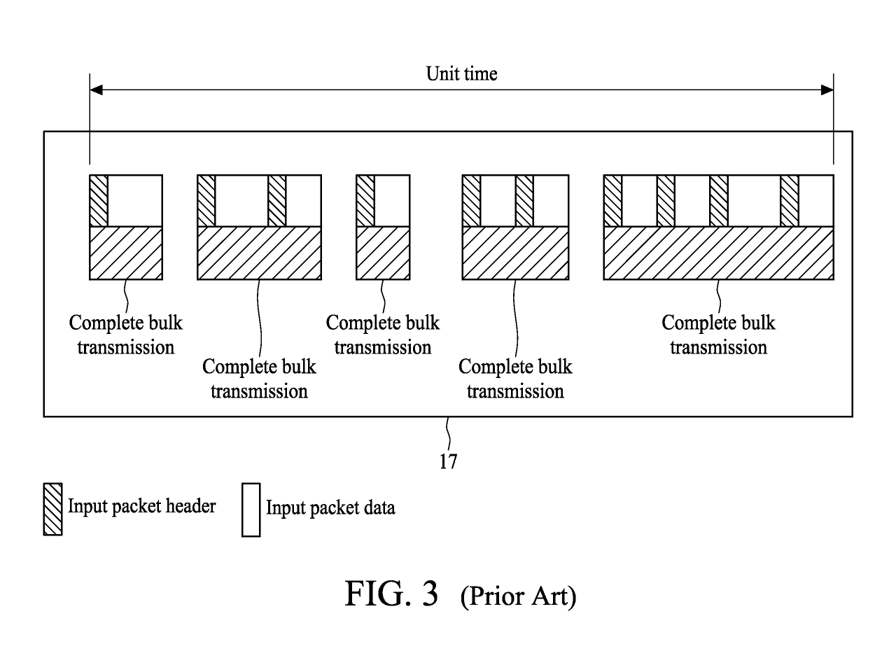

FIG. 4 shows a block diagram of the bulk transmission input control circuit in FIG. 1;

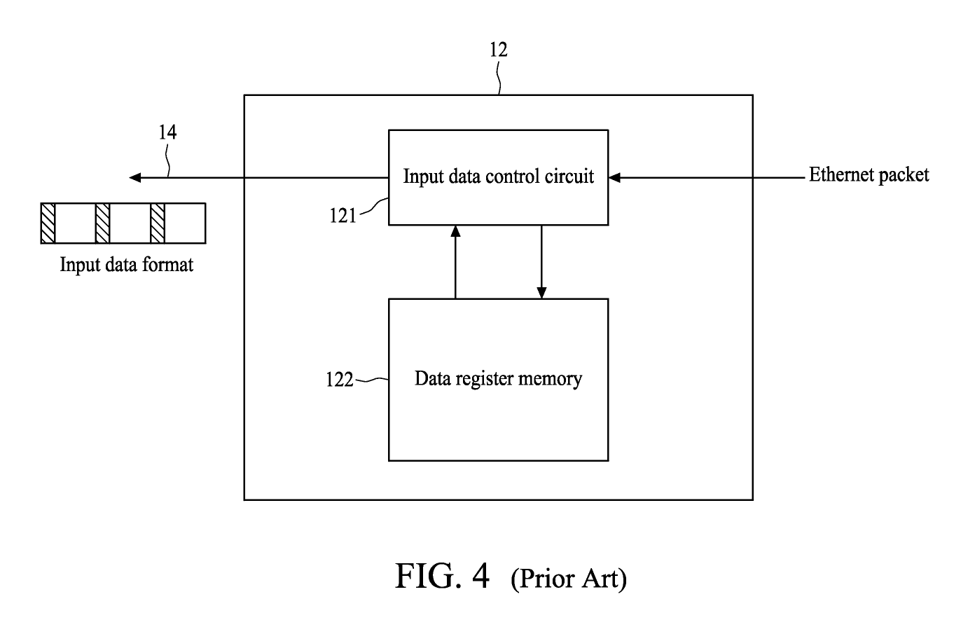

FIG. 5 shows a block diagram of a USB system according to one embodiment of the present invention;

FIG. 6 shows a schematic diagram of a format for input data according to one embodiment of the present invention;

FIG. 7 shows a schematic diagram of bulk transmission input frame format data according to one embodiment of the present invention; and

FIG. 8 shows a block diagram of a bulk transmission input control circuit according to one embodiment of the present invention.

### DETAILED DESCRIPTION

The present invention relates to a Universal Serial Bus (USB) device providing improved data transmission efficiency while transmitting data to a USB host. A bulk transmission input control circuit is used to enhance the efficiency of data transmission from the USB device to the USB host.

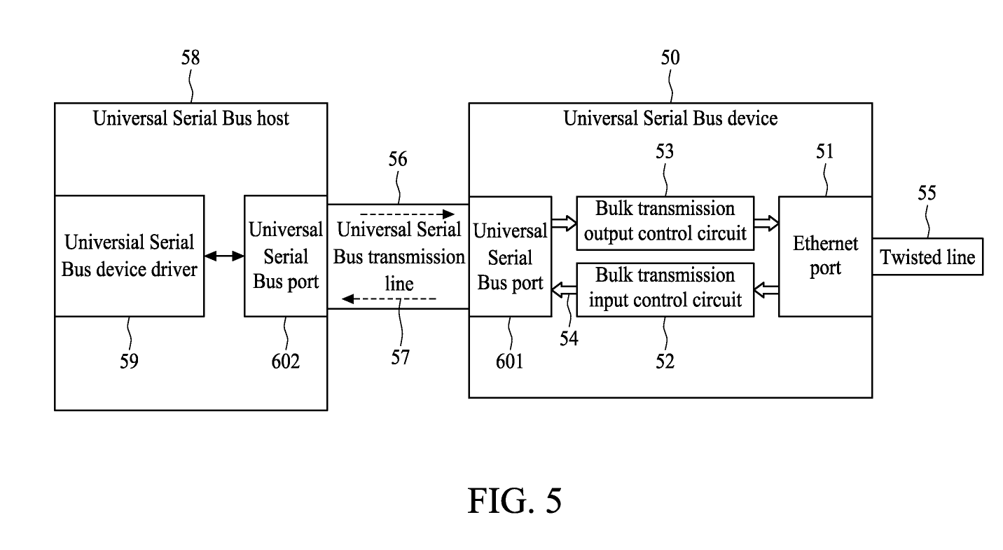

FIG. 5 shows a block diagram of a USB system according to one embodiment of the present invention. Referring to FIG. 5, the USB system includes a USB device 50 and a USB host 58. The USB device 50 includes an Ethernet port 51, a USB port 601, a bulk transmission output control circuit 53 and a bulk transmission input control circuit 52.

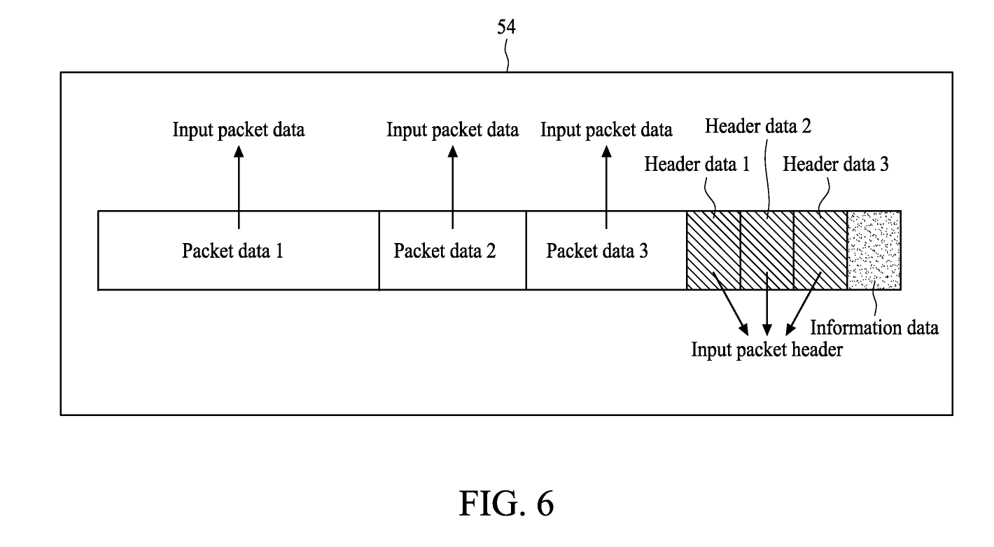

The USB device 50 connects to an external device (not shown) through a twisted line 55, and transmits input data in a format 54 (shown in FIG. 6) from the Ethernet port 51 through the bulk transmission input control circuit 52 to the USB port 601. The USB port 601 connects to a USB port 602 of the USB host 58 through a USB transmission line 56, and transmits data 57 in a bulk transmission input frame format to a USB driver 59 of the USB host 58.

The USB host 58 connects to the USB device 50 through the USB port 602 and the USB transmission line 56, and connects through the USB port 601, the bulk transmission output control circuit 53 and the Ethernet port 51 to the twisted line 55 so as to transmit data to the external device.

FIG. 6 shows a schematic diagram of the format 54 for input data according to one embodiment of the present invention. Referring to FIG. 6, the input data format 54 includes at least one packet data, such as packet data 1, packet data 2 and packet data 3, at least one header data, such as header data 1, header data 2 and header data 3, and a piece of information data. Furthermore, the packet data 1, packet data 2 and packet data 3 form a first group, while the header data 1, header data 2, header data 3 and the information data form a second group. The first group has a higher priority in the transmission sequence than the second group.

In the input data format 54, each of the packet data 1, packet data 2 and packet data 3 are input packet data of the bulk transmission input control circuit 12. Furthermore, the header data 1, header data 2 and header data 3 are the header data of the packet data 1, packet data 2 and packet data 3, respectively. Furthermore, the information data record other information.

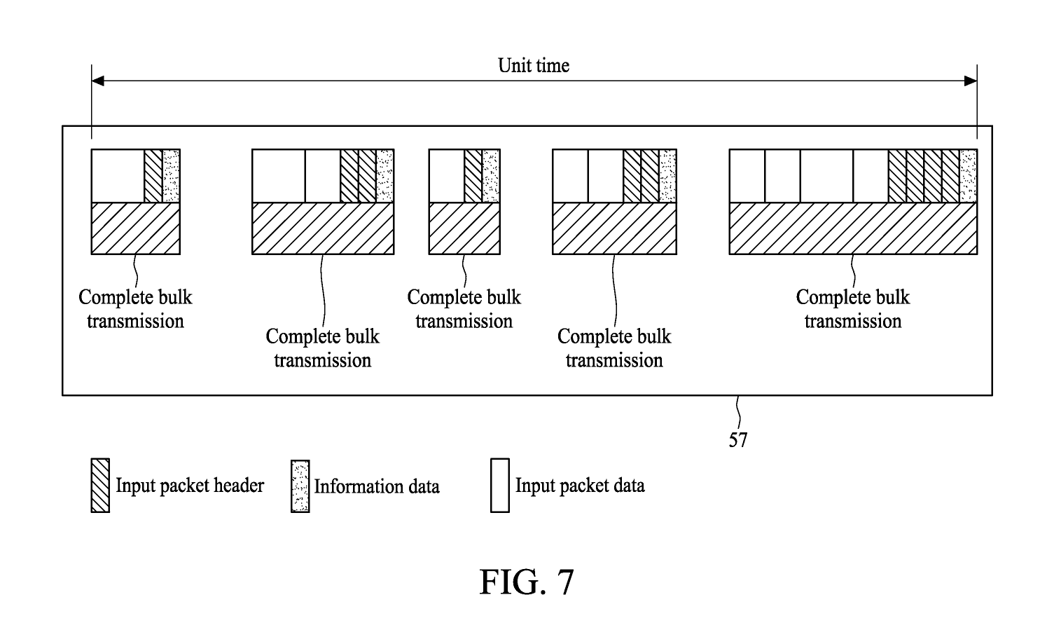

FIG. 7 shows a schematic diagram of the bulk transmission input frame format data 57 according to one embodiment of the present invention. Referring to FIG. 7, the bulk transmission input frame format data 57 include a plurality of input packet data, a plurality of input packet header data, a plurality of information data and a plurality of complete bulk transmission data.

The bulk transmission input frame format data 57 include a plurality of USB packets. Each of the USB packets includes at least one input packet data, at least an input packet header data corresponding to the at least one input packet data, a piece of information data and a piece of complete bulk transmission data. The at least one input packet data form a first group, while the at least one input packet header data and the information data form a second group. The first group has a higher priority in the transmission sequence than the second group.

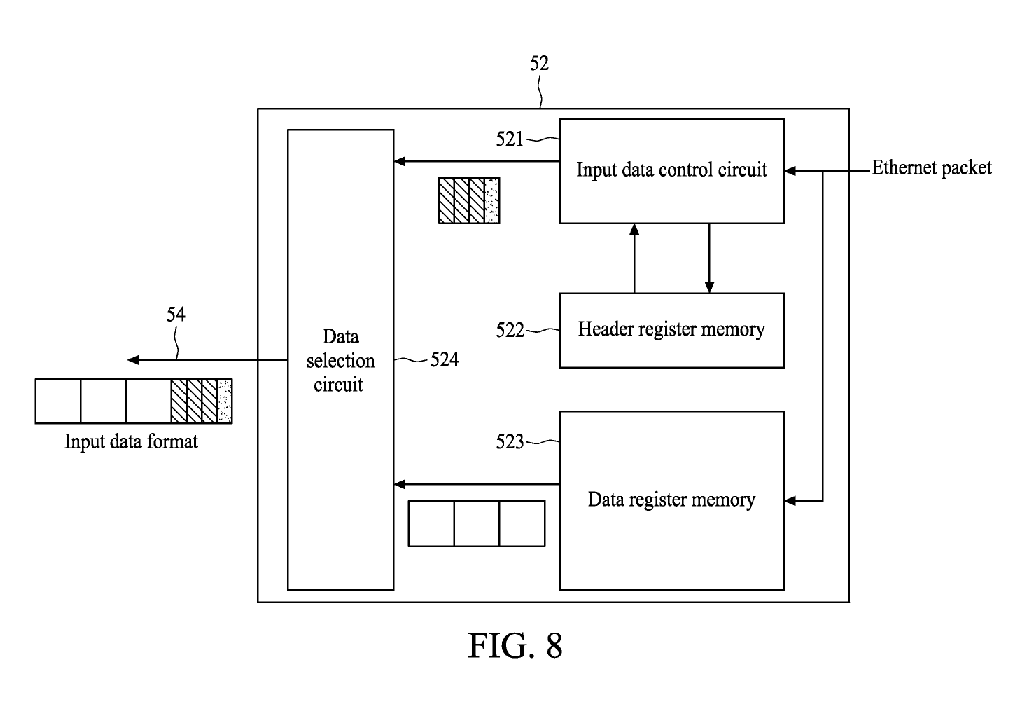

FIG. 8 shows a block diagram of the bulk transmission input control circuit 52 according to one embodiment of the present invention. Referring to FIG. 8, the bulk transmission input control circuit 52 includes a data register memory 523, a data selection circuit 524, a header register memory 522 and an input data control circuit 521.

In operation, the input data control circuit 521, upon receiving a first Ethernet packet, temporarily stores the packet data of the first Ethernet packet (hereinafter “the first packet data”) in the data register memory 523. The first packet data, after temporarily stored are transmitted to the data selection circuit 524. In response to the first packet data, the data selection circuit 524 receives an output of the data register memory 523, i.e. the first packet data, and transmits the first packet data to the USB host 58. In contrast, the conventional bulk transmission input control circuit does not determine whether to receive an Ethernet packet until each Ethernet packet data are completely transmitted to the input control circuit and, after determining to receive the Ethernet packet, transmits the Ethernet packet to a USB host.

The input data control circuit 521, in response to the transmission of the first packet data, for example, in response to an end of the transmission of the first packet data to the USB host 58, temporarily stores the header data of the first Ethernet packet (hereinafter “the first header data”) in the header register memory 522. The first header data record the length and characteristics of the transmitted first packet data. Moreover, the input data control circuit 521 records the number of Ethernet packets already transmitted by the bulk transmission input control circuit 52.

Before an interrupt signal is received, the input data control circuit 521, upon receiving a second Ethernet packet, temporarily stores the packet data of the second Ethernet packet (hereinafter “the second packet data”) in the data register memory 523. The second packet data, after temporarily stored, are transmitted to the data selection circuit 524. Upon receiving the second packet data, the data selection circuit 524 receives an output of the data register memory 523, i.e. the second packet data, and transmits the second packet data to the USB host 58. In response to the transmission of the second packet data, the input data control circuit 521 temporarily stores the header data of the second Ethernet packet (hereinafter “the second header data”) in the header register memory 522. The second header data record the length and characteristics of the transmitted second packet data. The input data control circuit 521 then records the number of Ethernet packets already transmitted by the bulk transmission input control circuit 52.

If an interrupt signal occurs, the data selection circuit 524 completes the transmission of the current packet data (for example the second packet data), and then receives an output of the input data control circuit 521. Meanwhile, based on the number of Ethernet packets already transmitted, the input data control circuit 521 retrieves a corresponding number of header data (for example, the first header data and the second header data) and transmits the retrieved header data to the data selection circuit 524, which in turn transmits the header data to the USB host 58. The input data control circuit 521, after retrieving all the header data, transmits a piece of information data at the end of the bulk transmission input data 54. The information data record the number of Ethernet packets received by the bulk transmission input control circuit 52 and the length of Ethernet data. The USB device driver 59 in the USB host 58 determines the position of each Ethernet packet header data based on the information data, then based on the header data determines whether to receive the Ethernet packet data corresponding to the header data, and subsequently transmits re-organized Ethernet packet data to a host internet application layer.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A Universal Serial Bus (USB) device, comprising:
an Ethernet port, configured to receive a first Ethernet packet; and
an input control circuit, comprising:
a data register memory;
a header register memory; and
an input data control circuit, in response to the first Ethernet packet, storing first packet data of the first Ethernet packet in the data register memory, then transmitting the first packet data to a USB host, and in response to the transmission of the first packet data, storing a first header data of the first Ethernet packet in the header register memory.

2. The USB device of claim 1, wherein the input data control circuit is configured to record the number of Ethernet packets transmitted to the input control circuit.

3. The USB device of claim 2, wherein the input control circuit further comprises a data selection circuit, configured to selectively receive an output of the data register memory and an output of the input data control circuit.

4. The USB device of claim 3, wherein the input data control circuit, in response to an interrupt signal, retrieves a corresponding number of header data from the header register memory based on the number of Ethernet packets already transmitted.

5. The USB device of claim 4, wherein the input data control circuit transmits information data after retrieving the corresponding number of header data.

6. The USB device of claim 5, wherein the data selection circuit, in response to the interrupt signal, receives the output of the input data control circuit.

7. The USB device of claim 5, wherein the input data control circuit, in response to a second Ethernet packet, stores second packet data of the Ethernet packet in the data register memory, then transmits the second packet data to the USB host, and in response to transmission of the second packet data, stores a second header data of the second Ethernet packet in the header register memory.

8. The USB device of claim 7, wherein the input control circuit transmits data in a data format to the USB host, the data format including at least one packet data, at least one header data and the information data.

9. The USB device of claim 8, wherein the at least one packet data form a first group, and the at least one header data and the information data form a second group, the first group having a higher priority in the transmission sequence than the second group.

10. A USB device, comprising:
an Ethernet port, configured to sequentially receive at least one Ethernet packet, wherein each of the at least one Ethernet packet comprises header data and packet data; and
an input control circuit, configured to transmit data in a data format to a USB host, wherein the data format comprises at least one packet data corresponding to the at least one Ethernet packet, and at least one header data corresponding to the at least one Ethernet packet;
wherein the at least one packet data form a first group, and the at least one header data form a second group, the first group having a higher priority in the transmission sequence than the second group.

11. The USB device of claim 10, wherein the input control circuit comprises:
a data register memory;
a header register memory; and
an input data control circuit, in response to a first Ethernet packet, storing first packet data of the first Ethernet packet in the data register memory, then transmitting the first packet data to the USB host, and in response to the transmission of the first packet data to the USB hosts, storing first header data of the first Ethernet packet in the header register memory.

12. The USB device of claim 11, wherein the input data control circuit is configured to record the number of Ethernet packets that have already been transmitted to the input control circuit.

13. The USB device of claim 12, wherein the input control circuit further comprises a data selection circuit, configured to selectively receive an output of the data register memory and an output of the input data control circuit.

14. The USB device of claim 13, wherein the input data control circuit, in response to an interrupt signal, retrieves a corresponding number of header data from the header register memory based on the number of Ethernet packets that have already been transmitted.

15. The USB device of claim 14, wherein the input data control circuit transmits information data after retrieving the corresponding number of header data.

16. The USB device of claim 15, wherein the data selection circuit, in response to the interrupt signal, receives the output of the input data control circuit.

17. The USB device of claim 16, wherein the data format comprises at least one packet data, at least one header data and the information data.

18. The USB device of claim 17, wherein the at least one packet data form a first group, and the at least one header data and the information data form a second group, wherein the first group has a higher priority in the transmission sequence than the second group.
